(19) United States
(12) Patent Application Publication
(10) Pub. No.: US 2004/0077406 A1
(43) Pub. Date: Apr. 22, 2004

(54) Sense of force imparting type input device

(75) Inventor: Mikio Onodera, Miyagi-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/684,907

(22) Filed: Oct. 14, 2003

(30) Foreign Application Priority Data
Oct. 17, 2002 (JP) 2002-303261

(51) Int. Cl. G06F 17/00

(52) U.S. Cl. 463/30; 463/38

(57) ABSTRACT

Since an outer casing having an opening, an operating lever being pivotably supported by a stick controller disposed in the outer casing, encoders for detecting the amount of pivotal movement and the direction of pivotal movement of the operating lever, and motors for imparting a desired external force to the operating lever are provided, the outer casing is formed with a projecting shoulder of a square shape in plan view, four outer surfaces of the projecting shoulder constitute fingerhooks respectively, and the operating lever is projected from the opening formed at the center of the projecting shoulder, when the operator pivots the operating lever, he/she can pivot the operating lever with his/her finger in a state in which his/her other fingers are placed on any one of fingerhooks of the projecting shoulder.

### BACKGROUND OF THE INVENTION

1. Field of the Invention

The present invention relates to a sense of force imparting type input device having a force feedback function which imparts an external force such as feeling of resistance, thrust, and so on to an operator who pivots an operating lever according to the operating state of the operating lever and, more specifically, to a sense of force imparting type input device suitable to be used in on-vehicle control equipment.

2. Description of the Related Art

In recent years, there is proposed a sense of force imparting type input device with a force feedback function in which adjusting functions for on-vehicle control equipment such as air conditioners, audio sets, navigation systems, and so on, are all integrated into a single operating lever, and external forces such as feeling of resistance, thrust, and the like are imparted corresponding to the amount of operation and the direction of operation of the operating lever when selecting equipment or adjusting functions of the selected equipment by this operating lever, so that a feeling of operation is improved and reliable operability is ensured.

In the related art, a known sense of force imparting type input device of this type includes detecting means for detecting the amount of operation and the direction of operation of the operating lever, an actuator for imparting an external force to the operating lever, control means for controlling driving of actuator based on output signal supplied from the detecting means, and a monitor for displaying various menus and a current position of the operating lever (Japanese Unexamined Published Patent JP-A 2002-189560 (P.4-6. FIG. 1))

The detecting means includes a converting unit for converting a pivotal movement of the operating lever into rotary movement of two revolving bodies that are orthogonal with respect to each other, and a detecting unit such as rotary encoder for converting the amount of rotation and the direction of rotation of these revolving bodies into electric signals, and the actuator is constructed of a motor or the like. The control means receives a detected signal supplied from the detecting unit of the detecting means and supplies a desired control signal to the actuator based on the detected signal, and then displays the operating position (current position) of the operating lever on the monitor disposed on an instrument panel or the like in a vehicle cabin. The control signals are signals corresponding to a feeling of operation imparted to the operating lever, and include several types such as a type which generates vibrations, or a type which varies the operating force. The upper end portion of the operating lever is projected from the outer surface in a vehicle cabin such as a center console box, and a plurality of key switches corresponding to the equipment menu indicating various equipment displayed on the monitor are arranged on the outer surface.

In the sense of force imparting type input device generally constructed as described above, the equipment menu indicating various equipment such as air conditioner, audio set, navigation system, and so on is displayed on the monitor as an initial screen, and when the operator presses one of key switches, the menu display screen is switched to a function screen for the equipment corresponding to the pressed key switch, so that the functions of the selected equipment can be adjusted by pivoting the operating lever. For example, when the operator selects the air conditioner by operating an optional key switch, functions such as temperature adjustment or airflow adjustment relating the air conditioner are displayed on the monitor, so that the temperature or the airflow can be adjusted by moving the cursor on the monitor by tilting the operating lever to a corresponding direction. In this case, the control means receives a detected signal supplied from the detecting means, and supplies a desired control signal to the actuator based on the detected signal, so that an external force according to the amount of operation and the direction of operation thereof is imparted to the operating lever. Therefore, the operator can recognize that the operating lever is operated to the intended direction by touch, and thus the feeling of operation is improved and the reliable operability is ensured.

In the sense of force imparting type input device in the related art, when selecting equipment or function of the equipment by pivoting the operating lever projected from the outer casing in the corresponding direction, the operator has to pivot the operating lever to the desired direction while viewing a cursor on the monitor because the angle at which the operator grips the operating lever is not necessarily constant, which has been a factor to deteriorate the operability of the operating lever. In addition, since the operator is required to perform such troublesome operation as pressing one of key switches to select desired equipment from the equipment menu on the monitor, and then moving his/her hand to the operating lever and selecting the function of the selected equipment, there exists a problem in that the usability is not good.

### SUMMARY OF THE INVENTION

In view of such circumstances in the related art, it is an object of the present invention to enable the operation to pivot the operating lever to be performed easily by touch and to provide a sense of force imparting type input device which is superior in operability and usability.

In order to achieve the above-described object, a sense of force imparting type input device according to the present invention includes an outer casing having an opening, an operating lever having a fulcrum inside the outer casing and being pivotably supported, detecting means for detecting the operating state of the operating lever, an actuator for imparting an external force to the operating lever, control means for controlling driving of the actuator based on output signals supplied from the detecting means, wherein the outer casing is formed with a projecting shoulder the outer surface of which serves as fingerhook, so that the operating lever is projected from the opening formed at the center of the projecting shoulder.

In the sense of force imparting type input device thus constructed, since the operator can pivot the operating lever by his/her finger in a state in which his/her other fingers are placed on the fingerhook on the outer surface of the projecting shoulder, the distance between the fulcrum and the point of application of force during pivotal operation is decreased and, simultaneously, the direction of pivotal movement of the operating lever can be recognized by touch with the aid of the fingerhook. Therefore, the operability is enhanced and the usability is improved.

In the construction described above, it is preferable if the surface of the fingerhook on the projecting shoulder is roughened because slippage of the fingers can be prevented, and is also preferable if the fingerhook of the projecting shoulder is formed with recesses at a plurality of positions because the direction of pivotal movement of the operating lever can be recognized with reference to the positions of the respective recesses.

In the construction described above, it is preferable if the shape of the projecting shoulder in plan view is substantially square although the shape of the projecting shoulder is not specifically limited because the operator can easily recognize the direction of pivotal movement of the operating lever from the extending direction of four fingerhooks on the projecting shoulder. In this case, it is further preferable if each of the fingerhook of the projecting shoulder is formed with a recess.

In the construction described above, preferably, a plurality of key switches are arranged on the surface of the projecting shoulder so as to surround the operating lever. In this construction, when selecting desired equipment from the equipment menu displayed on the monitor for performing adjustment of a function of the selected equipment, the operator can perform the operation to press the key switch and the operation to pivot the operating lever continuously by touch with his/her hand supported on the outer casing. Therefore, the operability is enhanced and the usability is improved.

### BRIEF DESCRIPTION OF THE DRAWINGS

FIG. 1 is a sketch drawing of a sense of force imparting type input device according to an embodiment of the present invention;

FIG. 2 is a schematic drawing of the sense of force imparting type input device;

FIG. 3 is a perspective view of a stick controller provided in the sense of force imparting type input device;

FIG. 4 is a lateral cross-sectional view of the stick controller;

FIG. 5 is a vertical cross sectional view of the stick controller;

FIG. 6 is a cross sectional view showing an internal construction of an operating knob provided in the sense of force imparting type input device;

FIG. 7 is an explanatory drawing showing a state of pivotal operation of an operating lever;

FIG. 8 is an explanatory drawing showing an example of operation of the operating knob;

FIG. 9 is an explanatory drawing showing contents displayed on a monitor;

FIG. 10 is an explanatory drawing showing contents displayed on the monitor;

FIG. 11 is an explanatory drawing showing contents displayed on the monitor; and

FIG. 12 is a perspective view showing a modification of a projecting shoulder.

### DESCRIPTION OF THE PREFERRED EMBODIMENTS

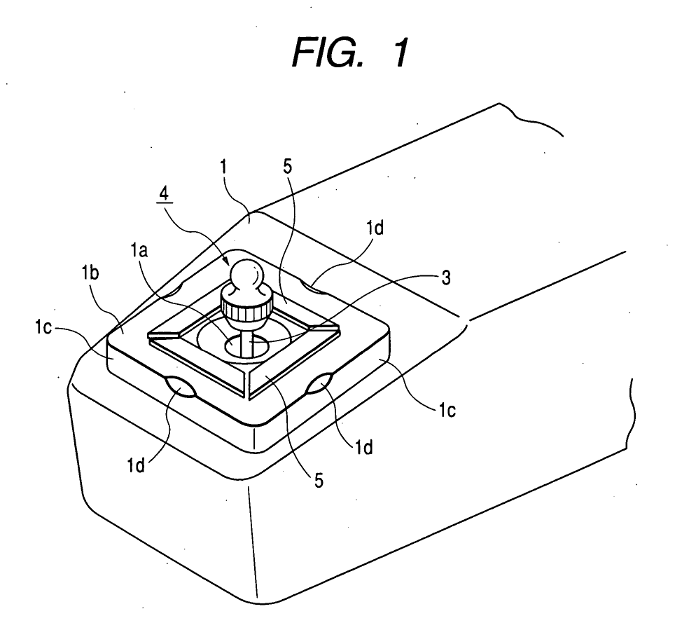

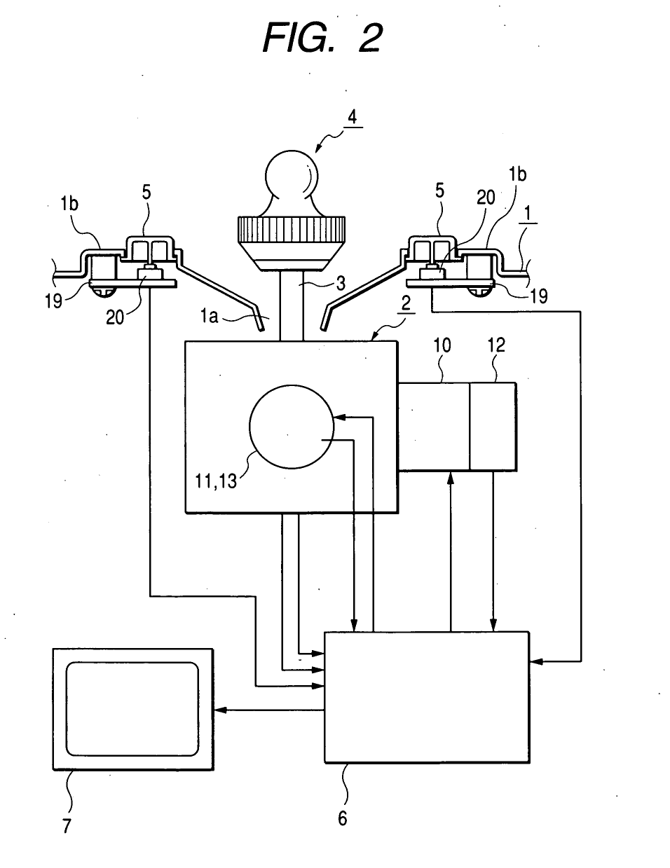

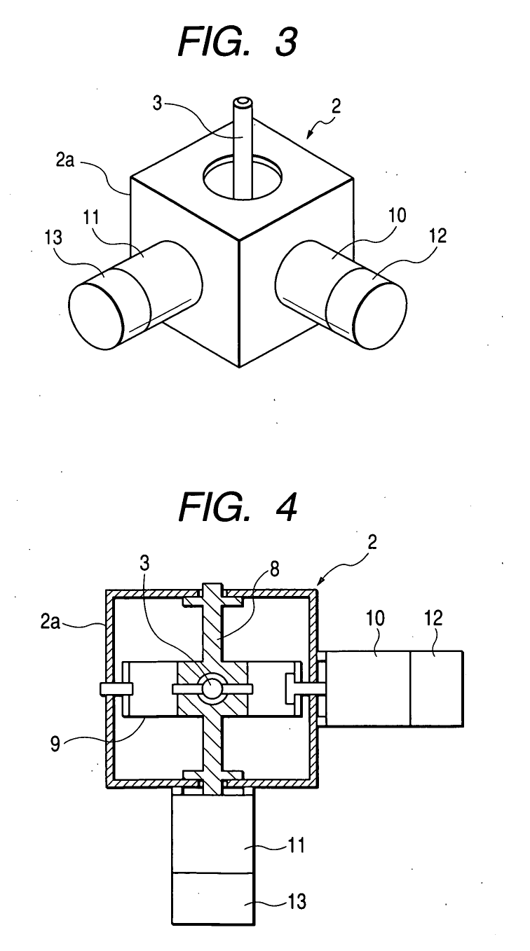

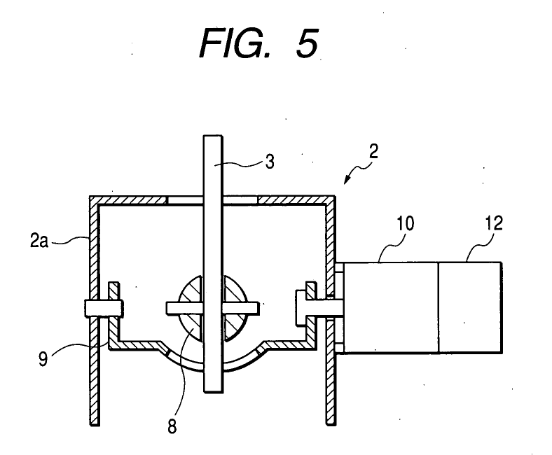

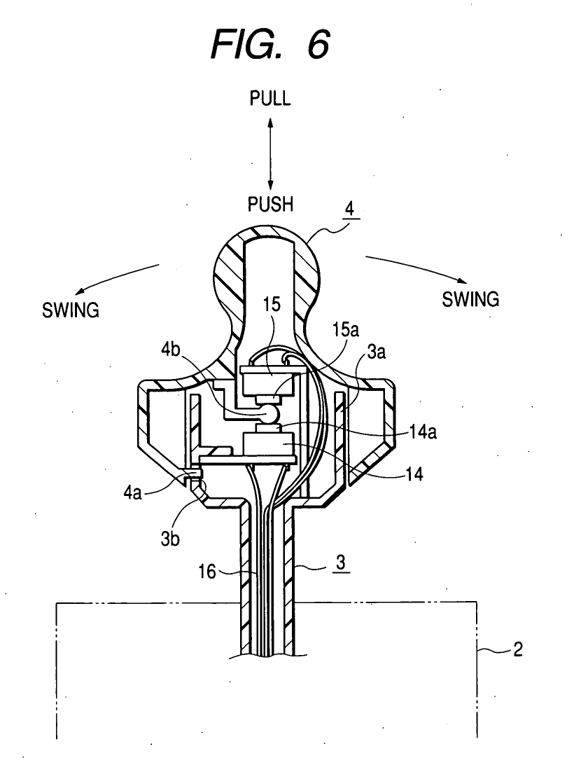

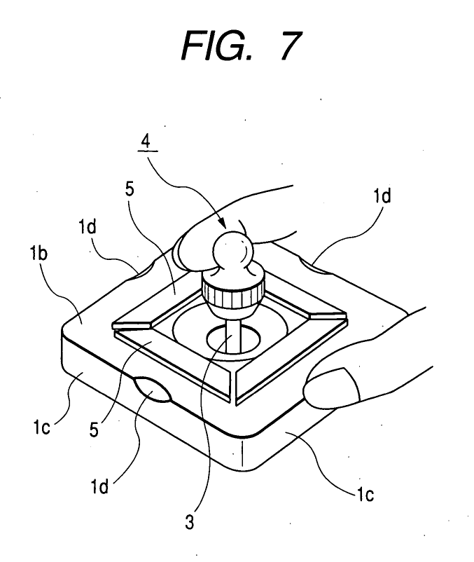

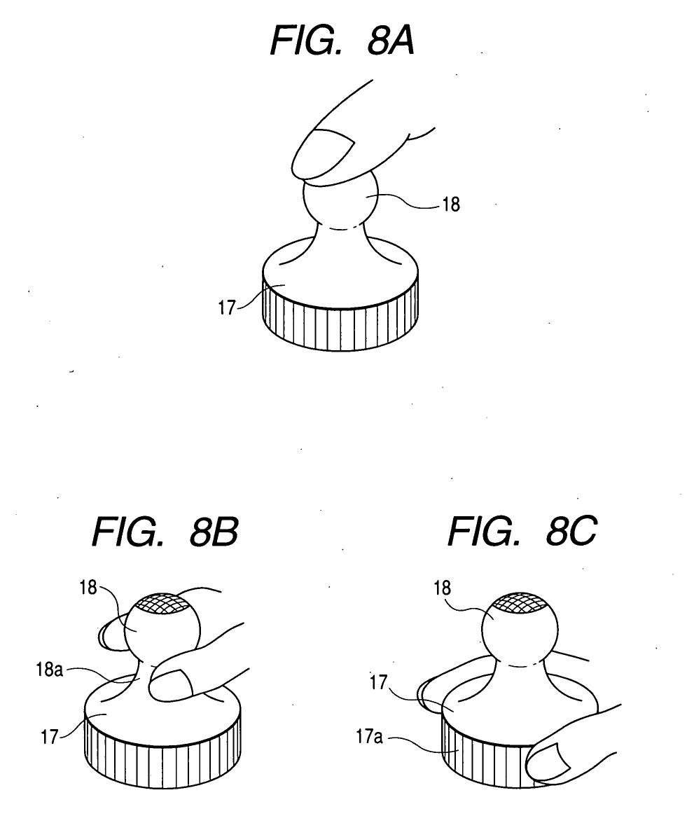

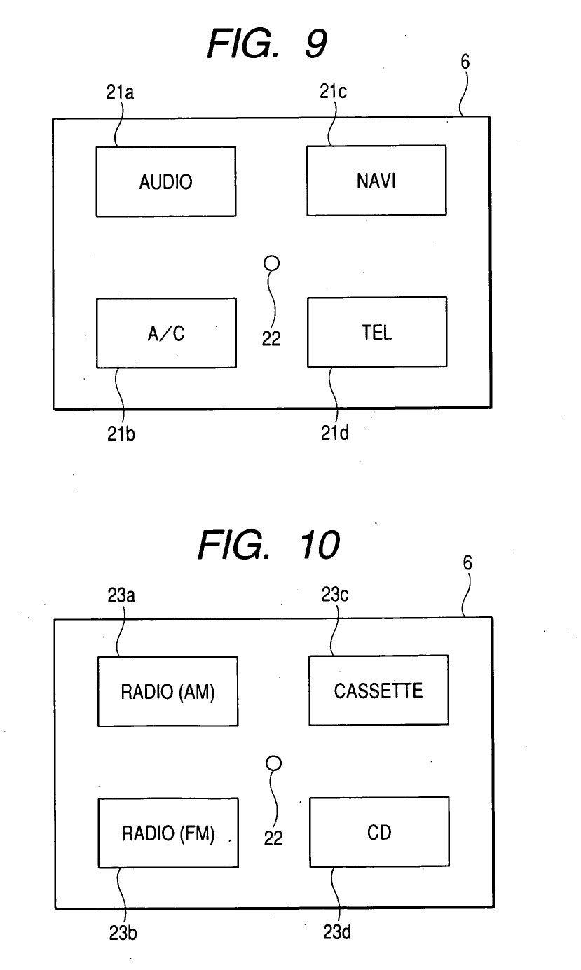

Referring now to the drawings, an embodiment of the present invention will be described. FIG. 1 is a sketch drawing of a sense of force imparting type input device according to an embodiment of the present invention; FIG. 2 is a schematic drawing of the sense of force imparting type input device; FIG. 3 is a perspective view of a stick controller provided in the sense of force imparting type input device; FIG. 4 is a lateral cross-sectional view of the stick controller; FIG. 5 is a vertical cross sectional view of the stick controller; FIG. 6 is a cross sectional view showing an internal construction of an operating knob provided in the sense of force imparting type input device; FIG. 7 is an explanatory drawing showing a state of pivotal operation of an operating lever; FIG. 8 is an explanatory drawing showing an example of operation of the operating knob; and FIG. 9 to FIG. 11 are explanatory drawings showing contents displayed on a monitor.

As shown in FIG. 1 and FIG. 2, the sense of force imparting type input device according to the present embodiment mainly includes an outer casing 1 having an opening 1a, a stick controller 2 disposed inside the outer casing 1, an operating lever 3 pivotably supported by the stick controller 2, an operating knob 4 mounted to the upper end of the operating lever 3, four key switches 5 arranged on the outer casing 1, a control unit 6, and a monitor 7. The outer casing 1 is, for example, an upper surface of an armrest disposed between the seats in the vehicle cabin. However, it may be other members, such as a center console panel. As will be described later, the outer casing 1 is formed with a projecting shoulder 1b projecting from the surface thereof, and the operating lever 3 projects through the opening 1a formed at the center of the projecting shoulder 1b into the vehicle cabin.

As shown in FIG. 3 to FIG. 5, the stick controller 2 has a box-shape enclosure 2a, and a pair of revolving bodies 8, 9 are rotatably supported in the enclosure 2a so as to be orthogonal with respect to each other. On two of outer surfaces of the enclosure 2a, which is orthogonal with respect to each other, there are provided motors 10, 11 which serve as actuator, and shafts of the revolving bodes 8, 9 are connected to rotating shafts of the motors 10, 11. Rotary encoders 12, 13 are arranged coaxially with the motors 10, 11 respectively, and the rotating shafts of the motors 10, 11 are connected to the rotor units of the encoders 12, 13. Both of the encoders 12, 13 constitute detecting means for detecting the operating state of the operating lever 3. In other words, the lower end portion of the operating lever 3 engages the intersecting portions of both of the revolving bodies 8, 9, and thus when the operating lever 3 is pivoted to a corresponding direction, such pivotal movement is converted into the rotary movements of both of the revolving bodies 8, 9, and detected signals according to the amount of pivotal movement and the direction of the pivotal movement of the operating lever 3 are supplied from both of the encoders 12, 13. Each of the encoders 12, 13 has a restoring spring integrated therein, not shown, and thus the operating lever 3 is automatically restored to the upright posture by these restoring springs.

As shown in FIG. 6, a storage section 3a is integrally formed at the upper end of the operating lever 3 projected from the opening 1a, and first and second push switches 14, 15 are mounted in the storage section 3a. The first push switch 14 has a stem 14a so that when the stem 14a is pressed against a spring force of the restoring spring, not shown, provided therein, a movable contact point, also not shown, comes into contact with a fixed contact point to turn ON. The second push switch 15 is also constructed in the same manner, and both stems 14a, 15b of the first and the second push switches 14, 15 face with each other at a predetermined interval. The first and the second push switches 14, 15 are provided with wire leads 16 connected thereto, and the wire leads 16 are connected to the control unit 6 through the inside of the hollow operating lever 3.

The operating knob 4 is fitted onto the storage section 3a of the operating lever 3 so that the operating knob 4 can reciprocate along the axis of the operating lever 3 by sliding on the storage section 3a. However, the extent of the movement along the axis of the operating knob 4 is limited within a predetermined range since a stopper projection 4a of the operating knob 4 is inserted into an engaging hole 3b of the storage section 3a, and simultaneously, the operating knob 4 is prevented from falling off the operating lever 3. The operating knob 4 is provided with a pusher 4b therein, and the pusher 4b is positioned between the stems 14a, 15a of the first and the second push switches 14, 15. Therefore, the operating knob 4 is stably held at the neutral position without being subjected to a load because the pusher 4b is subjected to an urging force, which is uniform in the vertical direction, from the restoring springs integrated in the first and the second push switches 14, 15. Therefore, when the operating knob 4 is pushed with reference to the neutral position, the first push switch 14 is turned ON by the pusher 4b, and when the operating knob 4 is pulled with reference to the neutral position, the second push switch 15 is turned ON by the pusher 4b.

As shown in FIG. 1 and FIG. 7, the projecting shoulder 1b of the outer casing 1 is formed into a square shape in plan view, and four outer surfaces of the projecting shoulder 1b constitute fingerhooks 1c. The surfaces of these fingerhooks 1c are roughened into, for example, a satin finished surface, etched surface, or knurled surface, and each of the fingerhook 1c is formed with a recess 1d in a curved shape at the upper center thereof. The operating knob 4 includes a column shaped large diameter portion 17 positioned on the outside of the storage section 3a of he operating lever 3 and a protuberant portion 18 projecting upward from the center of the large diameter portion 17. The protuberant portion 18 is formed with a narrowed portion 18a at the midpoint thereof. The large diameter portion 17 is formed with knurl 17a on the outer peripheral surface thereof, and the protuberant portion 18 is also provided with knurl 18b for providing a roughened surface at the top of the spherical body thereof. In addition, the four key switches 5 are exposed from the surface of the projecting shoulder 1b, and the key switches 5 are arranged so as to surround the upper end portion of the operating lever 3 and the operating knob 4. As shown in FIG. 2, a circuit board 19 is mounted on the back surface of the outer casing 1, and four push switches 20 facing the respective key switches 5 are mounted on the circuit board 19.

The control unit 6 is provided with a CPU and a memory integrated therein. The CPU receives a detected signal supplied from both of the encoders 12, 13, determines a first control signal corresponding to the detected signal based on data or program stored in the memory, and supplies the first control signal to both of the motors 10, 11. The first control signals are signals corresponding to a feeling of operation imparted to the operating lever 3 and the operating knob 4, and include several types such as a type which generates vibrations, or a type which varies the operating force. When the signal is vibration generating type, the first control signals which represent the intensity of vibrations, the shape of vibrations, the loading time, the frequency, and so on are generated. When the signal is operating force varying type, the first control signals which represent the intensity of the operating force, the direction of generation of the operating force (that is, resistance force or thrust), the loading time, and so on are generated. The control unit 6 is supplied with ON signals for the first and the second push switches 14, 15 and the respective push switches 20, and supplies the second control signal to the monitor 7 according to such ON signals or signals detected by the both of the encoders 12, 13. The second control signals are signals for determining or canceling the action for selecting the equipment or the function displayed on the monitor 7, or for displaying a cursor corresponding to the operating position of the operating lever 3 on the monitor 7. The monitor 7 is disposed in the instrument panel or the like in the vehicle cabin.

Subsequently, referring to FIG. 9 to FIG. 11, the operation of the sense of force imparting type input device arranged as described above will be described.

When a system of sense of force imparting type input device is actuated, as shown in FIG. 9, the equipment menu indicating four options 2la-21d of equipment such as “AUDIO”, “A/C”, “NAVI”, and “TEL”, respectively, and a cursor 22 showing the current position of the operating lever 3 are shown on the monitor 7 as an initial screen. In this case, the operating lever 3 is held in an upright position at the center by the restoring springs of both of the encoders 12, 13, and the cursor 22 is positioned substantially at the center of the monitor 7. The equipment menu options 21a-21d correspond to the respective key switches 5, and the contents of the equipment menu options 21a-21d may be displayed on the respective key switches 5 or on the outer casing 1 in the vicinity thereof as needed. The activating operation of the system may be performed, for example, by pressing a start button, not shown, disposed at a predetermined position in the vehicle cabin, or may be performed in conjunction with an accessory mode of an ignition key.

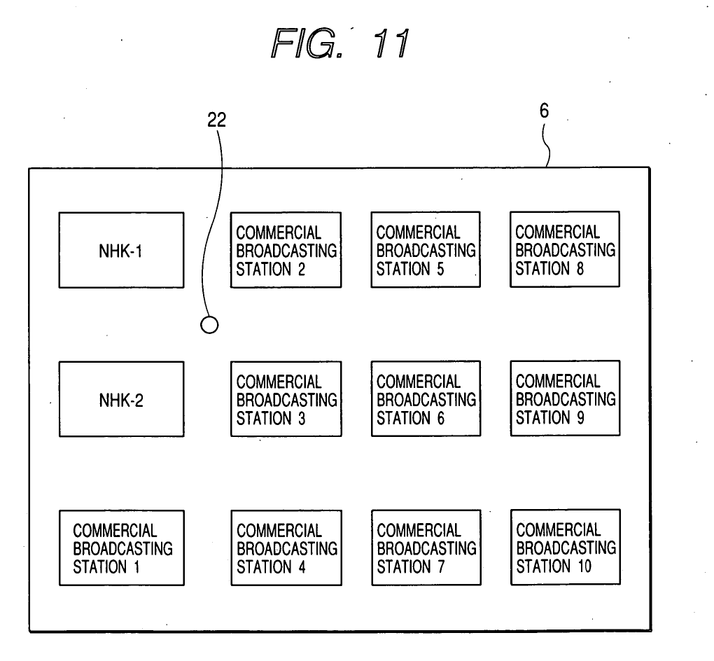

When the operator presses any one of key switches 5 in a state in which the equipment menu options 21a-21d are displayed on the monitor 7, the push switch 20 disposed downwardly of the key switch 5 is turned ON, and the ON signal is input to the control unit 6. Accordingly, the control unit 6 supplies the second control signal to the monitor 7, and the display screen on the monitor 7 is switched to a function adjustment screen for the equipment which corresponds to the pressed key switch 5. For example, when the key switch 5 corresponding to the equipment menu option 21a is pressed, selection of the equipment displayed as the equipment menu option 21a, “AUDIO” is determined, and then, as shown in FIG. 10, the display screen of the monitor 7 is switched to a menu indicating four options, such as “radio (AM)”, “radio (FM)”, “cassette”, and “CD”, 23a to 23d. The pressing operation of such key switches 5 may be performed by the operator by pressing the top surface of the corresponding key switch 5 with a suitable finger with his/her hand supported on the outer casing 1.

When the operator places his/her finger on the operating knob 4 and pivots the operating lever 3 into one direction in a state in which the display screen of the monitor 7 is switched to the function adjusting screen for the selected equipment, the detected signal supplied from both of the encoders 12, 13 of the stick controller 2 is received by the control unit 6. Then, the control unit 6 supplied the second control signal corresponding to the detected signal to the monitor 7, and the cursor 22 moves to a position corresponding to the current position of the operating lever 3. In association with such movement of the cursor 22, the control unit 6 outputs the first control signal corresponding to the detected signal to both of the motors 10, 11, so that a desired feeling of operation is imparted to the operating lever 3. For example, when the cursor 22 reaches the area of the menu option 23a indicating “radio (AM)”, an operating force against the pivoting direction of the operating lever 3 is imparted, and when the cursor 22 enters into the area of the menu option 23a, an operating force promoting the pivotal movement of the operating lever 3 is generated. Accordingly, the operator who placed his/her finger on the operating knob 4 can recognize that the operating lever 3 is pivoted to the desired direction by touch. In the case described above, the fact that the cursor 22 reaches the area of the menu option 23a is notified by a feeling of clicking, and then the touch that the cursor 22 is drawn into the center of the menu option 23a may be recognized.

The operator may perform the pivotal operation of the operating lever 3 by placing his/her thumb on one of the fingerhooks 1c of the projecting shoulder 1b with his/her hand supported on the outer casing 1 and pivoting the operating knob 4 with, for example, his/her forefinger, as shown in FIG. 7. In this case, since each of the fingerhook 1c is formed with the recess 1d at the center thereof and the adjacent two fingerhooks 1c are orthogonal with respect to each other, the operator can recognize the direction of pivotal movement of the operating lever 3 by the position of the recess 1d and the extending direction of the fingerhook 1c by touch. Therefore, the operator can continuously perform the pressing operation of the key switch 5 and the pivotal operation of the operating lever 3 described above by touch with his/her hand supported on the outer casing 1, and thus the operability may be enhanced and the usability may be improved. When it is adapted to change the displayed color of the menu option 23a in addition to exertion of an external force to the operating lever 3 as described above when the cursor 22 reached the area of the desired menu option 23a, the operator can recognize that the operating lever 3 is pivoted to the intended direction not only by a sense of force but also visually.

In this manner, adjustment of the function of the “radio (AM)” that corresponds to the menu option 23a is selected by moving the cursor 22 to the center position of the desired menu option 23a. However, the selection of adjustment of the function is determined when the operator pushes the operating knob 4 along the direction of the axis of the operating lever 3. In other words, when the operator pushes the operating knob 4, the stem 14a of the first push switch 14 is turned ON by being pushed by the pusher 4b, and the control unit 6 receives the ON signal and supplies the second control signal to the monitor 7. Accordingly, as shown in FIG. 11, when the display screen of the monitor 7 is switched to the menu including options such as “NHK (Japan Broadcasting Corporation)-1”, “NHK-2”, “Commercial Broadcasting Stations 1-10”, for example, “NHK-1” is selected as described above by pivoting the operating lever 3, and the operating knob 4 is pushed to determine the selected option, the operator can listen to broadcasting of NHK-1 from the radio in vehicle cabin. Such pushing operation of the operating knob 4 can be performed by pressing his/her finger on the top surface of the protuberant portion 18 as shown in FIG. 8A, by catching and pressing the narrowed portion 18a of the protuberant portion 18 with two fingers as shown in FIG. 8B, or by catching and pressing the large diameter portion 17 with two fingers as shown in FIG. 8C. Any operation may be performed continuously in a state in which the operating lever 3 is pivoted.

When the operator wants to cancel the selected menu by the pivotal operation of the operating lever 3 during the menu selection described above, he/she may pull the operating knob 4 along the direction of the axis of the operating lever 3 to cancel the selected menu. For example, when the menu shown in FIG. 11 is displayed on the monitor 7, and the operating knob 4 is pulled in a state in which the “NHK-1” is selected by moving the cursor 22, the stem 15a of the second push switch 15 is turned ON by being pressed by the pusher 4b, and the control unit 6 receives the ON-signal and supplies the second control signal to the monitor 7. Consequently, the selection of “NHK-1” is cancelled and the display screen of the monitor 7 is returned to the state shown in FIG. 11. Such pulling operation of the operating knob 4 can be performed, for example, by pulling up the protuberant portion 18 with the narrowed portion 18a caught by two fingers as shown in FIG. 8B, or by pulling up the large diameter portion 17 caught by two fingers as shown in FIG. 8C. In any case, the operator can perform the canceling operation continuously in a state in which the operating lever 3 is pivoted.

Although the case of “selecting a radio station” of the audio set has been described thus far, selection of the function of other equipment can be made through the same basic operation except that the display of the monitor 7 is different. For example, by pressing the key switch 5, selecting “A/C” from the equipment menu options 21a-21d shown in FIG. 9, and pivoting the operating lever 3, the temperature or the airflow of the air conditioner can be adjusted.

As described above, the sense of force imparting type input device according to the present embodiment includes the projecting shoulder 1b of a square shape in plan view projecting from the surface of the outer casing 1, the four outer surfaces of the projecting shoulder 1b constitute the fingerhooks 1c respectively, and the operating lever 3 projects from the opening 1a formed at the center of the projecting shoulder 1b. Therefore, when the operator pivots the operating lever 3, he/she can pivot the operating lever 3 with his/her finger in a state in which his/her other fingers are placed on any one of the fingerhooks 1cof the projecting shoulder 1b. Therefore, the distance between the fulcrum and the point of application of force during pivotal operation of the operating lever 3 is decreased and, simultaneously, the direction of pivotal movement of the operating lever 3 can be recognized by touch with the aid of the fingerhook 1c. Therefore, the operability is enhanced and the usability is improved.

In addition, since the surface of each of the fingerhook 1c is roughened by etching or knurl, and the recess 1d is formed at the center of each of the fingerhooks 1c, slippage of the finger placed on the fingerhook 1c may be prevented, and the finger is stably fitted to the recess 1d of the fingerhook 1c. From this point, the operability is enhanced and the usability is improved.

In addition, since the plurality of key switches 5 are arranged on the surface of the projecting shoulder 1b so as to surround the operating lever 3, and the operation selected from the equipment menu options 21a-21d of the equipment displayed on the monitor 7 is determined by pressing the corresponding key switch 5, when the operator selects a desired equipment from the equipment menu options 2la-21d displayed on the monitor 7 and adjust the function of the selected equipment, the operator can perform the operation to press the key switch 5 and the operation to pivot the operating lever 3 continuously by touch with his/her hand supported on the outer casing 1. From this point, the operability is enhanced and the usability is improved as well.

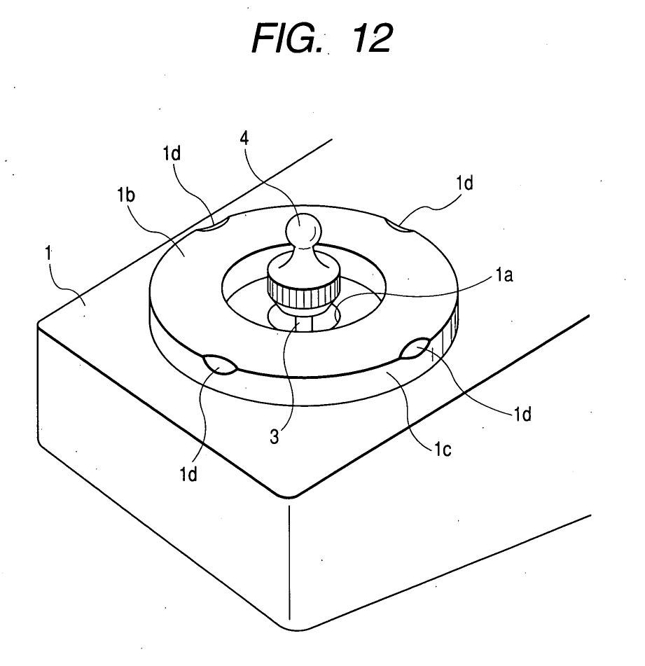

In the above-described embodiment, the case in which the projecting shoulder 1b is formed into a square shape in plan view has been described. However, the shape of the projecting shoulder 1b is not limited thereto. For example, as shown in FIG. 12, a construction in which the outer peripheral surface of the projecting shoulder 1b formed into a circular shape in plan view constitutes the fingerhook 1c, and the plurality of recesses 1d are formed on the fingerhook 1c at regular intervals may be employed. Alternatively, the projecting shoulder 1b may be formed into a polygonal shape in plan view.

In the embodiment described above, the case in which the plurality of key switches 5 are arranged on the surface of the projecting shoulder 1b has been described. However, the key switches 5 may be arranged at other places on the outer casing 1.

The present invention is embodied in a manner described above, and provides following advantages.

Since the outer casing is formed with the projecting shoulder projecting from the surface thereof and the outer surfaces of the projecting shoulder constitute fingerhooks, and the operating lever is projected from the opening formed at the center of the projecting shoulder, when the operator pivots the operating lever with his/her finger in a state in which his/her other fingers are placed on the fingerhook on the projecting shoulder, the distance between the fulcrum and the point of application of force during pivotal operation is decreased and, simultaneously, the direction of pivotal movement of the operating lever can be recognized by touch with the aid of the fingerhook. Therefore, the sense of force imparting type input device in which the operability is enhanced and the usability is improved may be realized.

What is claimed is:

1. A sense of force imparting type input device comprising:
an outer casing having an opening;
an operating lever having a fulcrum inside the outer casing and being pivotably supported;
detecting means for detecting the operating state of the operating lever;
an actuator for imparting an external force to the operating lever; and
control means for controlling driving of the actuator based on output signals supplied from the detecting means,
wherein the outer casing is formed with a projecting shoulder the outer surface of which serves as fingerhook, so that the operating lever is projected from the opening formed at the center of the projecting shoulder.

2. A sense of force imparting type input device according to claim 1, wherein the surface of the fingerhook is roughened.

3. A sense of force imparting type input device according to claim 1, wherein the fingerhook is formed with recesses at a plurality of positions on the outer surface side.

4. A sense of force imparting type input device according to claim 2, wherein the fingerhook is formed with recesses at a plurality of positions on the outer surface side.

5. A sense of force imparting type input device according to claim 1, wherein the projecting shoulder is formed into a substantially square in plan view.

6. A sense of force imparting type input device according to claim 4, wherein the fingerhooks of the projecting shoulder are each formed with a recess.

7. A sense of force imparting type input device according to claim 1, wherein a plurality of key switches are arranged on the surface of the projecting shoulder so as to surround the operating lever.

8. A sense of force imparting type input device according to claim 2, wherein a plurality of key switches are arranged on the surface of the projecting shoulder so as to surround the operating lever.

9. A sense of force imparting type input device according to claim 3, wherein a plurality of key switches are arranged on the surface of the projecting shoulder so as to surround the operating lever.

10. A sense of force imparting type input device according to claim 4, wherein a plurality of key switches are arranged on the surface of the projecting shoulder so as to surround the operating lever.

11. A sense of force imparting type input device according to claim 5, wherein a plurality of key switches are arranged on the surface of the projecting shoulder so as to surround the operating lever.

12. A sense of force imparting type input device according to claim 6, wherein a plurality of key switches are arranged on the surface of the projecting shoulder so as to surround the operating lever.
